(19) United States
(12) Patent Application Publication
(10) Pub. No.: US 2017/0122170 A1
(43) Pub. Date: May 4, 2017

(54) Filter System and Filtration Method for Fluid Reservoirs

(71) Applicant: Caterpillar Inc., Peoria, IL (US)

(72) Inventors: Matthew F. Fahrenkrug, Chillicothe, IL (US); Jason W. Hudgens, Washington, IL (US); Theron J. Cassidy, Peoria, IL (US); Shawn Herold, East Peoria, IL (US)

(73) Assignee: CATERPILLAR INC., Peoria, IL (US)

(21) Appl. No.: 14/928,782

(22) Filed: Oct. 30, 2015

(51) Int. Cl. F01N 3/20; B01D 29/11; B01D 35/02

(52) U.S. Cl. CPC F01N 3/2066; B01D 35/02; B01D 29/114; F01N 2610/1406; F01N 2610/1426

(57) ABSTRACT

A fluid reservoir for accommodating a fluid reductant used in an SCR exhaust treatment process may include various styles or designs of bag filters to filter debris and contaminants from the reductant prior to being channeled out of the reservoir. To secure the bag filter to a header assembly accommodating the various inlet and outlet tubes, in one aspect, the header assembly may be associated with a base assembly designed to reduce leak paths allowing reductant to bypass the bag filter. In another aspect, the bag filter may be secured directly to the header assembly without the base assembly.

### TECHNICAL FIELD

This disclosure relates generally to diesel exhaust fluid delivery systems used in association with engine emission control systems and, more particularly, to a filter system and filtration method for use with reductant agent delivery systems.

### BACKGROUND

One known method for abating certain diesel engine exhaust constituents is by use of an exhaust after-treatment system that utilizes Selective Catalytic Reduction (SCR) of nitrogen oxides. In a typical SCR system, a fluid reductant or reducing agent, sometimes referred to as diesel exhaust fluid (DEF) and which may include urea or a urea-based water solution, is mixed with exhaust gas before being provided to an appropriate catalyst. In some applications, the reductant is injected directly into an exhaust passage through a specialized injector device. In the case of urea, the injected reductant mixes with exhaust gas and breaks down to provide ammonia (NH₃) in the exhaust stream. The ammonia then reacts with nitrogen oxides (NOₓ) in the exhaust at a catalyst to provide nitrogen gas (N₂) and water (H₂O).

As can be appreciated, SCR systems require the presence of some form of reductant sufficiently close to the engine system such that the engine can be continuously supplied during operation. Various reductant delivery systems are known and used in engine applications. In known reductant injection systems, a reservoir is installed onto a vehicle for containing the reductant, which is drawn from the reservoir and delivered in metered amounts to the engine exhaust system. The reservoir has a finite urea capacity such that periodic replenishment of the reductant within the reservoir is required. In certain applications, such as mining, construction, farming and other field applications, reductant replenishment may be carried out in the work environment of the machine. Such refilling or replenishment operations are typically carried out by dispensing reductant into the reservoir through a removable reservoir cap. As can be appreciated, dirt and other debris may fall within the reservoir, especially during a refilling operation, which may present problems if the dirt and/or other debris is ingested into a pump drawing reductant from the reservoir, and/or is delivered with the reductant to the reductant injector, which typically has close clearances and small injection orifices that can bind or become plugged by the debris.

In the past, various solutions have been proposed to mitigate the presence of debris within a reductant reservoir. Most such solutions propose adding filtering media to a fill opening of the reservoir, or adding filters in line with a reductant supply line within the system at a location upstream of a reductant pump and/or before the reductant injector. However, such known solutions present certain challenges. For example, a filter disposed at an inlet of the container may impede the rapid filling of the container, which is desired, especially since a lengthy filling process may rob the machine of profitable time in service. Moreover, the aqueous components of reductant fluids are susceptible to thermal effects such as breakdown at high temperatures or freezing at low temperatures, which makes their presence in lengthy in-line supply conduits and/or filters undesirable due to crystallization effects and/or freezing within the filter. Such conditions, which require the addition of heaters and/or other temperature control devices to be added to reductant supply systems, increase the cost and complexity of those systems.

### SUMMARY

The disclosure describes, in one aspect, a base assembly having a clamshell type, two-piece construction for connecting a bag filter to a header that is disposable on a fluid reservoir for fluid reductant used in SCR exhaust aftertreatment processes. The base assembly can include a first semicircular base portion and a second semicircular base portion that, when joined together, provide the cylindrical shape for the base portion. Each of the first and second semicircular base portions includes a planar axial face and a semi-cylindrical wall extending perpendicularly from the planar axial face. The curve defined by the semi-cylindrical wall of the first semicircular base portion concludes in a first abutment edge and a second abutment edge and the curve defined by the semi-cylindrical wall of the second semicircular base portion concludes in a third abutment edge and fourth abutment edge. When the first and second semicircular base portions are assembled, the first abutment edge and the third abutment edge form a first contiguous abutting seam and the second abutment edge and the fourth abutment edge for a second contiguous abutting seam so that the base portion is substantially fluid tight.

In another aspect, the disclosure describes a header assembly that is insertable into a fluid reservoir for reductant fluid usable in an SCR aftertreatment process. The header assembly includes a header having a header flange and a header boss descending from the header flange. The head flange further has a larger flange diameter than the boss diameter of the header boss. The header assembly further includes a mounting plate having a planar bottom plate and a circumferential wall extending perpendicularly from the planar bottom plate to provide a cup-shaped adapted to attach to the header boss. The circumferential wall of the mounting plate further has a mounting plate diameter dimensioned to circumscribe the boss diameter. The header assembly can further includes a bag filter secured to the mounting plate and descending downwards from the header.

In yet another aspect, the disclosure describes a header assembly insertable in a fluid reservoir containing reductant fluid usable in an SCR exhaust aftertreatment process. The header assembly includes a header having a header flange with a flange diameter and header boss protruding from the header flange and having a boss diameter smaller than the flange diameter. The header assembly further is made of a combined base/plate structure integrally formed together. The combined base/plate structure includes a base assembly portion having a planar axial surface and a mounting plate raised above the planar axial surface. The mounting plate is adaptable for mounting to an underside of the header. Additionally, at least one supply tube is disposed through the circular flange and secured in the header to descend through the base/plate structure into the reservoir.

### BRIEF DESCRIPTION OF THE DRAWINGS

FIG. 1 is a schematic block diagram of an internal combustion engine coupled to various exhaust aftertreatment systems including an SCR system in accordance with the disclosure.

FIG. 2 is a perspective view of a reductant reservoir for accommodating a fluid reductant agent isolated from the SCR system of FIG. 1.

FIG. 3 is a cross-sectional elevational view of the reductant reservoir taken along line 3-3 of FIG. 2 and illustrating the internal components of the reservoir.

FIG. 4 is a perspective view of a header assembly accommodating the fluid inlets and outlets of the reductant reservoir, the header assembly having a filter assembly including a bag filter and a base assembly adapted to be partially inserted into the reservoir.

FIG. 5 is a perspective view of a first semicircular base portion of the base assembly for mounting to the header assembly, the first semicircular base portion forming part of a clamshell style construction for the base assembly.

FIG. 6 is a perspective view of a second semicircular base portion complementary to the first semicircular base portion to complete the clamshell style base assembly.

FIG. 7 is a fragmentary side elevational view of the header assembly illustrating the clamshell style base assembly mounted to the header by insertion of the mounting tabs above a mounting plate descending from the header.

FIG. 8 is a perspective view of an alternative embodiment of a semicircular base portion for a clamshell style base assembly utilizing gaskets and/or o-rings for sealing between the complementary first and second semicircular base portions.

FIG. 9 is a perspective view of a second semicircular base portion complementary to the first semicircular base portion illustrated in FIG. 8.

FIG. 10 is a perspective view of an embodiment of a cup-shaped mounting plate adapted to secure the bag filter to the header assembly.

FIG. 11 is a side elevational view of the mounting plate of FIG. 10 illustrating an o-ring groove for retention of an o-ring for securing the bag filter thereto.

FIG. 12 is a perspective view of the mounting plate attached to the underside of the header and configured to receive and secure the bag filter thereto with an o-ring.

FIG. 13 is a perspective view of another embodiment of a combined base/plate structure having the base assembly integrally formed with the mounting plate in accordance with the disclosure.

FIG. 14 is a cross-sectional view of a reservoir similar to FIG. 3 illustrating an alternative embodiment of the bag filter and an inlet filter.

### DETAILED DESCRIPTION

This disclosure relates to emission control systems for machines and, more particularly, to reductant filtering systems for use with SCR-based after-treatment systems for diesel engines used on stationary or mobile machines. The machines contemplated in the present disclosure can be used in a variety of applications and environments. For example, any machine that performs some type of operation associated with an industry such as mining, construction, farming, transportation, marine or any other industry known in the art is contemplated. For example, the type of machine contemplated herein may be an earth-moving machine, such as a wheel loader, excavator, dump truck, backhoe, material handler, locomotive, paver or the like. Apart from mobile machines, the machine contemplated may be a stationary or portable machine such as a generator set, an engine driving a gas compressor or pump, and the like. Moreover, the machine may include or be associated with work implements such as those utilized and employed for a variety of tasks, including, for example, loading, compacting, lifting, brushing, and include, for example, buckets, compactors, forked lifting devices, brushes, grapples, cutters, shears, blades, breakers/hammers, augers, and others.

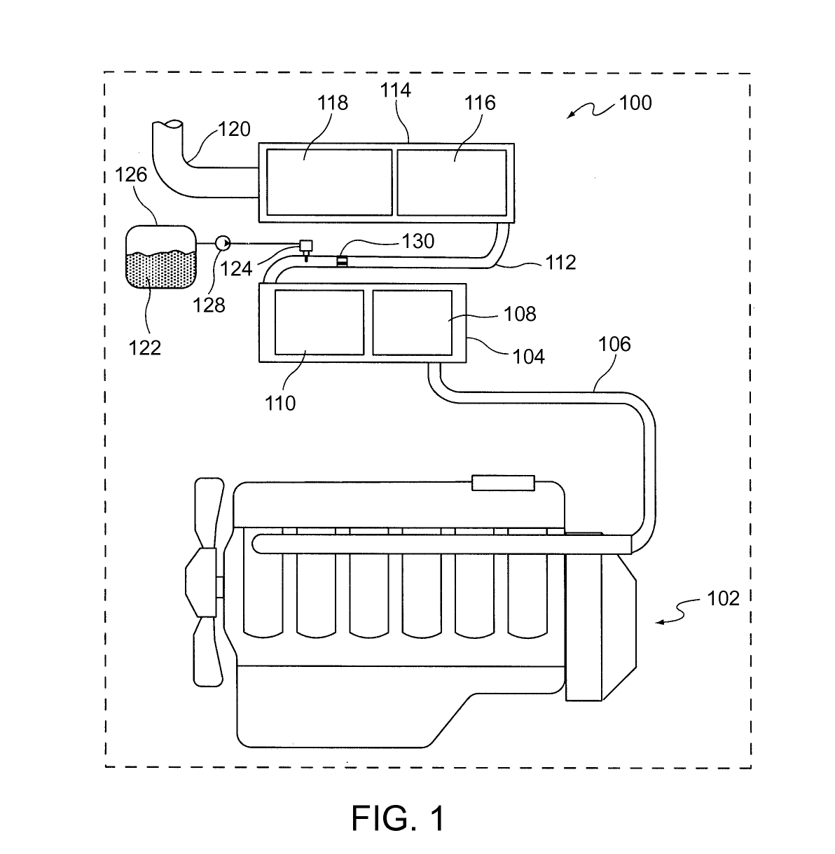

Now referring to the drawings, wherein like reference numbers refer to like elements, there is illustrated in FIG. 1 a representative block diagram of an exhaust aftertreatment system 100 associated with an internal combustion engine 102 of a machine. The internal combustion engine 102 is designed to combust a hydrocarbon-based fuel such as diesel or gasoline and convert the potential chemical energy therein to mechanical power in the form of rotational motion. In the illustrated embodiment, the engine may be a compression ignition diesel engine, but in other embodiments may be a spark ignition gasoline engine, a gas turbine, etc. The aftertreatment system 100 may be modularly packaged as shown in the illustrated embodiment for retrofit onto existing engines or, alternatively, for installation on new engines. In the illustrated embodiment, the aftertreatment system 100 includes a first module 104 that is fluidly connected to an exhaust conduit 106 from the engine 102. During engine operation, the first module 104 is arranged downstream of the engine 102 to internally receive engine exhaust gas from the conduit 106. The first aftertreatment module 104 may contain various exhaust gas treatment devices such as a diesel oxidation catalyst (DOC) 108 and a diesel particulate filter (DPF) 110, but other devices may be used. The first aftertreatment module 104 and the components found therein are optional and may be omitted for various engine applications in which the exhaust-treatment function provided by the first module 104 is not required. In the illustrated embodiment, exhaust gas provided to the first module 104 by the engine 102 may first pass through the DOC 108 and then through the DPF 110 before entering a transfer conduit 112.

The transfer conduit 112 fluidly interconnects the first aftertreatment module 104 with a second aftertreatment module 114 such that exhaust gas from the engine 102 may pass through the first and second aftertreatment modules 104 and 114 in series before being released to the environment from a stack 120 that is connected to the second aftertreatment module. In the illustrated embodiment, the second aftertreatment module 114 encloses a SCR catalyst 116 and an Ammonia Oxidation Catalyst (AMOX) 118. The SCR catalyst 116 and AMOX 118 operate to treat exhaust gas from the engine 102 in the presence of ammonia, which is provided after degradation of a fluid or liquid reductant agent or reductant injected into the exhaust gas in the transfer conduit 112.

More specifically, the fluid or liquid phase reductant 122 may be a urea-containing water solution, which may be commonly referred to as diesel exhaust fluid (DEF), is injected into the transfer conduit 112 by a reductant injector 124. The reductant 122 is contained within a tank-like reservoir 126 and is provided to the reductant injector 124 by a pump 128. As the reductant 122 is injected into the transfer conduit 112, it mixes with exhaust gas passing there through and is transferred therewith to the second aftertreatment module 114. To promote mixing of reductant with the exhaust gas, a mixer 130 comprised of baffles may be disposed along the transfer conduit 112. As can be appreciated, the location of the reductant injector 124 on the transfer conduit 112 can expose the injector to relatively high temperatures due to heating from exhaust gas during operation. In the illustrated exemplary embodiment, a flow of engine coolant is provided through the injector, but such coolant flow is optional.

One issue that may arise during operation is ingestion of dirt and/or other debris that may be found within the reservoir 126. Because urea may freeze, the inlet port within the reservoir 126 and other similar reservoirs is close to the bottom of the reservoir such that liquid urea may be drawn even if frozen urea is still present and floating in the reservoir when operation of the engine 102 starts and a heater disposed within the reservoir has not yet melted the entire amount of urea held in the reservoir. However, drawing liquid from the bottom of the reservoir 126 for this reason also makes the system more susceptible to ingestion of debris, dirt or other contaminants that may be present within the reservoir, for example, by falling into the reservoir through a fill-port opening during a filling operation.

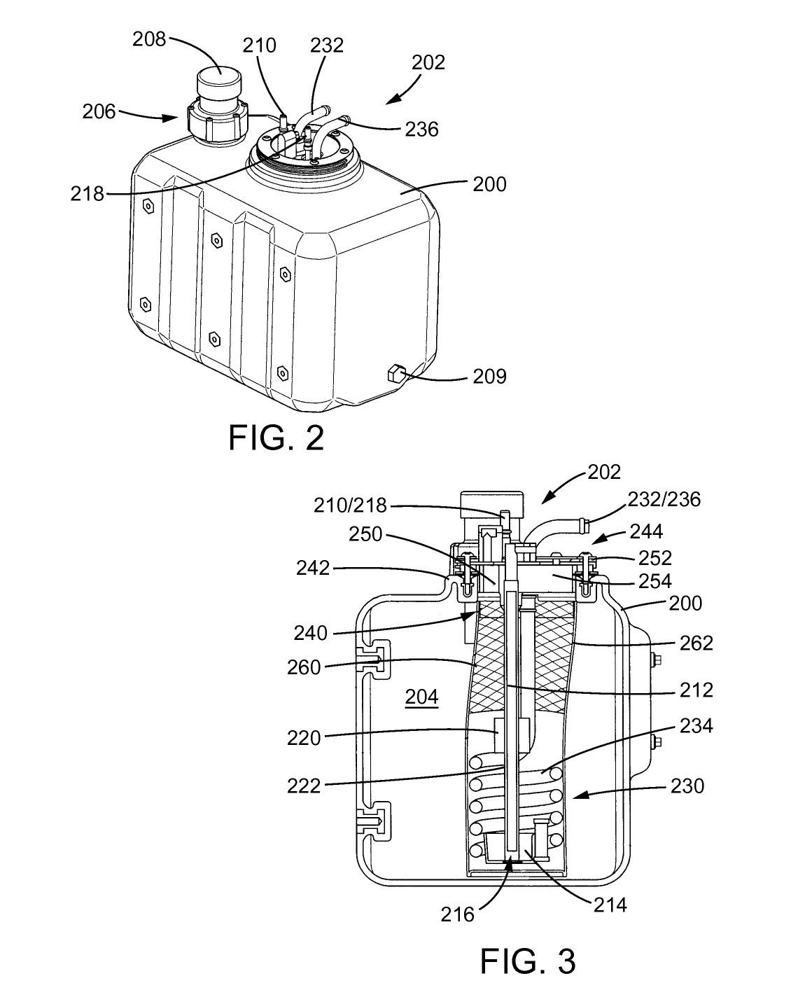

To accommodate the fluid reductant, a more detailed embodiment of the reservoir 200 is illustrated in FIGS. 2 and 3. To communicate the fluid reductant to the SCR system of the second aftertreatment module, the reservoir 200 includes a header assembly 202 installed on the top of the reservoir that is configured with various inlet and outlet tubes. The reservoir 200 shown is a single-piece molded plastic structure defining a generally hollow, internal reservoir volume 204 of suitable volume to hold a quantity of reductant for sustained treatment of the exhaust gasses. To fill the reservoir 200 with fluid reductant, the reservoir volume can be accessed through a fill opening 206 sealed by a removable fill cap 208 and to drain the reservoir cavity, a drain plug 209 can be disposed toward the bottom of the reservoir.

The header assembly 202 accommodates the inlet and outlet tubes for directing fluids to and from the reservoir volume 204. For example, to supply reductant to the SCR process via the reductant injector 124 and pump 128 (FIG. 1), the header assembly 202 includes a reductant supply port 210 disposed externally of the reservoir 200 and which forms part of a reductant supply tube 212 directed into the reservoir volume 204. To ensure the supply tube 212 has access to the reductant, the supply tube may extend to a sump 214 located at the bottom of the reservoir volume 204. The sump 214 may include an inlet filter 216 to remove debris and contaminants from the fluid reductant before it enters the supply tube 212. Likewise, to receive excess reductant that may be returned from the SCR process, the header assembly may include a reductant return port 218 that can discharge returning reductant proximate the top of the reservoir volume 204. In an embodiment, to measure the quantity of reductant in the reservoir 200, a reductant level sensor 220 slidably disposed on a sensor rod 222 can be installed in the reservoir volume 204 extending coaxially around and parallel to the supply tube 212. The reductant level sensor 220 can float on top of the fluid reductant and make readings or measurements with respect to the sensor rod 222 that indicate the reductant quantity.

Because the machine on which the reservoir is included may be exposed to very cold, outdoor temperatures, the header assembly 202 can accommodate a heater device 230 to prevent the fluid reductant from freezing. In the illustrated embodiment, the heater device 230 can be a liquid-to-liquid heat exchanger that uses heat provided by a flow of warm engine coolant to thaw frozen reductant fluid in the reservoir 200. Although a coolant-operated heater is shown, other types of heaters such as electrically powered or exhaust-gas heat powered heaters, to name a few, may be used. The coolant-operated heater includes a coolant inlet conduit 232 that supplies warmed coolant from an engine, for example, the engine 102 (FIG. 1), to a helical element or tubular heater coil 234, which is disposed within the reservoir volume 204 and in contact with the reductant therein. Coolant provided through the coolant inlet conduit 232 passes through the heater coil 234, thus heating the reductant. From the heater coil 234, the flow of coolant may return to the engine through a coolant outlet conduit 236.

To insert the header assembly 202 and the tubes it accommodates into the reservoir 200, a header opening 240 can be disposed through the top of the reservoir that provides access to the reservoir volume 204. In the embodiment best illustrated in FIGS. 2 and 3, the header opening 240 can be disposed through a reservoir embossment 242 of thicker or reinforced material formed on the external surface of the reservoir 200. To cooperatively mate with the header opening 240, the header assembly 202 can include a header 250 having a header flange 252 and a header boss 254 protruding or extending from the header flange. The header 250 may be made of molded plastic or machined metal and fixes the location of the inlet and outlet tubes disposed through it when installed in the header opening 240. In the illustrated embodiment, the header flange 252 and the header boss 254 may be circular in shape and may have a flange diameter and a boss diameter, respectively, with the boss diameter being less than the flange diameter. However, in other embodiments, other shapes for the header flange and boss are possible. When installed on the reservoir 200, the header flange 252 can be supported on the shoulder formed by the reservoir embossment 242 externally of the reservoir and the header boss 254 can be received into the header opening 240 such that the supply tube 212, sensor rod 222, and heater device 230 descend into the reservoir volume 204. The reservoir embossment 242 can have a circular shape with a diameter correspond to that of the header flange 252 and the header opening 240 be circular and have a diameter dimensioned to form a sliding fit with the header boss 254. The header assembly 202 is thus the primary conduit for fluid communication into and out of the reservoir 200. The header assembly 202 may be removably mounted to the reservoir 200 by a plurality of threaded fasteners 244 that can pass through the fastener bores 256 in the header 250 and thread into complementary threaded holes in the reservoir embossment 242. To remove debris, contaminants, or ice suspended in the reductant and to protect the extended supply tube 212 and heater device 230, a filtration assembly 260 including a bag-like filter 262 can be secured to the underside of the header assembly 202 and descend into the reservoir volume 204.

Referring to FIG. 3, the filtration assembly 260 and method of securing it to the header assembly 202 is better illustrated. The bag filter 262 may have a tubular, sleeve- or sock-like configuration of flexible or pliable material that is elongated and extends coextensively with the supply tube 212 and the heater device 230 to surround and enclose them. To provide the tubular shape, the bag filter 262 can have a closed end 264 and a mouth or bag opening 266 opposite the closed end. In an embodiment, the material of the bag filter can include supports or stitching to assist maintaining the tubular shape. The bag filter 262 can be made of a layer of polypropylene felt fabric or material, having a porosity of about 30 μm to 40 μm. The porosity of the bag filter 262 depends on the size of the debris expected to be present in the reservoir, and can change accordingly to be any size, although it may generally be expected for the porosity to be between 1 μm and 50 μm. As shown, the polypropylene felt has an inner, glazed side, and an outer, untreated or unglazed side with a felt feel, which increases the external area of the filter for trapping debris that may be moving around within the reservoir volume but that does not introduce loose fibers or debris from the filter on the internal, filtered side thereof. In certain embodiments, fabrics having both sides glazed may be used. Moreover, the polypropylene material may be replaced by a different material that is resistant to the type of fluid that will be filtered. Even further, although a single layer material is shown here for the bag filter 262, multiple layers or plies can be used. In one contemplated embodiment, two or more plies are used to increase filter efficiency. Regarding the construction of the bag filter 262, a flat sheet of fabric may be cut and sewn into the appropriate shape. Alternatively, the filter may be woven into a tubular shape by use of a sock knitting-type machine using polypropylene fibers and yarn.

When secured to the header assembly 202, the bag filter 262 may define an internal cavity or void dimensionally corresponding to the heater coil 234 of the heater device 230. Hence, when installed over the heater device 230, the heater coil 234 expands the bag filter 262 and keeps it from collapsing under the influence of reductant flow being drawn into the supply tube 212 for removal from the reservoir. This also prevents the bag from being drawn into and chocking of the supply tube 212. During operation, the fluid reductant can flow or permeate through the bag filter 262 from the surrounding reservoir volume 204 (FIG. 3) to access the supply tube 212, thereby filtering and removing debris and contamination from the reductant. The heater coil 234 may also keep the bag filter 262 from collapsing around and interfering with the reductant level sensor 220 on the sensor rod 222 that can be concentrically located within the helical heater coil. Hence, the bag filter 262 is prevented from interfere with the reductant quantity measurements.

To further assist the bag filter 262 in maintaining the expanded shape, the filtration assembly 260 can include a filter carrier 268 that is located proximate to the bag opening 266 of the bag filter 262 where it is attached to the header assembly 202. The filter carrier 268 has a hollow, generally cylindrical shape that corresponds to the cylindrical shape of the bag filter 262. An outer diameter of the filter carrier 268 is configured to fit within an inner diameter of the bag filter 262 and help the bag filter retain its shape during operation. Because the bag filter 262 in the configuration shown extends over and around the heater coil 234, the filter carrier 268 need not extend along the entire longitudinal length of the cylindrical bag filter 262 due to the internal support provided by the heater coil 234. As shown, the filter carrier 268 can be made from extruded plastic or by a woven mesh using plastic fibers. Plastic is used for the carrier in this embodiment instead of metal because of the corrosive nature of some reductant agent formulations but, depending on the type of reductant any other fluid that is used in the reservoir, any suitable materials can be used. In general, for reductant reservoirs containing urea, suitable materials can include metals such as Titanium, Ni—Mo—Cr—Mn—Cu—Si—Fe alloys, e.g. hastelloy c/c-276, highly alloyed austenitic Cr—Ni-steels and Cr—Ni—Mo-steels, and stainless steels. Other suitable, non-metal materials include Polyethylene, Polypropylene, Polyisobutylene, Perfluoroalkoxyl alkane (PFA), Polyfluoroethylene (PFE), Polyvinyldenefluoride (PVDF), Polytetrafluoroethylene (PTFE), Copolymers of vinylidenefluoride and hexafluoropropylene.

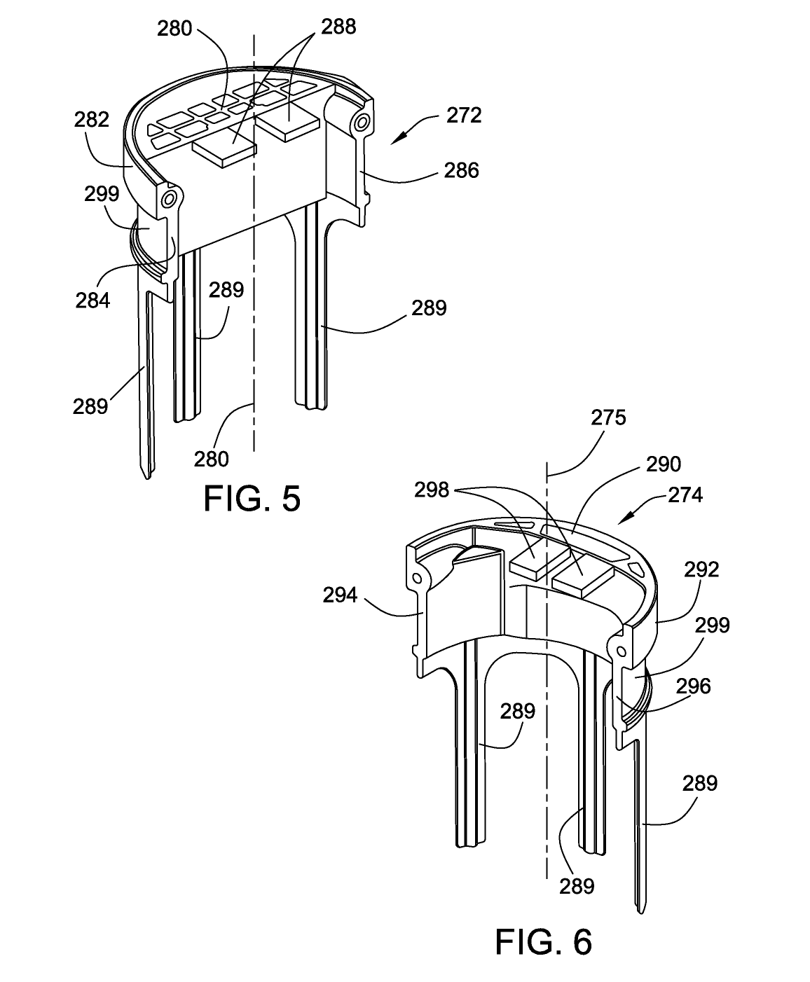

To secure the filtration assembly 260 to the header assembly 202, the filtration assembly can include or be operatively associated with a base assembly 270 adapted for connection between the header 250 and the bag filter 262. The base assembly 270 may have a cylindrical configuration that corresponds in dimension to the boss diameter of the header boss 254 and to the bag opening 266 of the bag filter 262. To facilitate assembly to the header 250, the base assembly 270 can have a two-piece, clamshell type construction as indicated in the embodiments shown in FIGS. 5 and 6. In particular, the first piece may be a first semicircular base portion 272 and the second piece may be second semicircular base portion 274 complementary with the first semicircular base portion 272 to provide the overall cylindrical shape of the base assembly 270; however, it should be noted that shapes and geometries are by way of example only and the first and second base portions may have other suitable shapes to correspond with the header opening on the reservoir. Further, although the illustrated first and second semicircular base portions 272, 274 are roughly hemispherical and compose approximately 180° of the cylindrical base assembly, in other embodiments, they may compose different degrees or arcs of the cylindrical base assembly. The first and second semicircular base portions 272 and 274 may be made from molded thermoplastic material, possibly reinforced with fiberglass, though in other embodiments the base portions can be made from other suitable materials such as cast, sintered or machined metal.

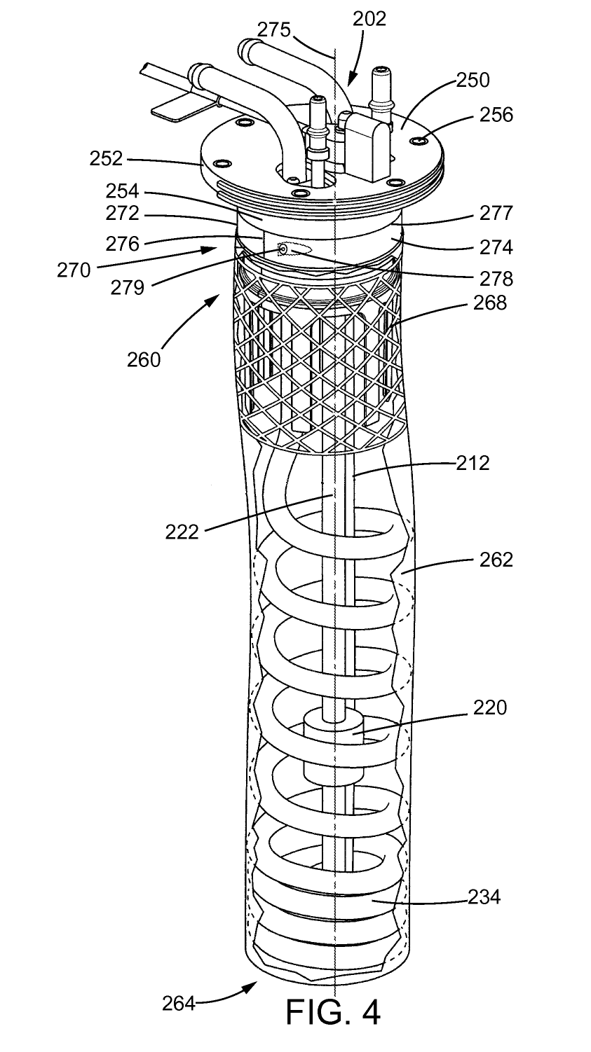

When assembled together to produce the base assembly 270, as illustrated in FIG. 4, the first semicircular base portion 272 and the second semicircular base portion 274 are positioned adjacent to each other and disposed underneath the header 250. The semicircular shape of the first and second base portions 272, 274 provides the circular configuration for the filter assembly 270 corresponding to the circular bag opening 266. Further, the adjacent the first and second semicircular base portions 272, 274 can delineate an axis line 275 that concentrically orientates the other components of the header assembly 202. When assembled together, the first and second semicircular base portions 272, 274 are abutted adjacent to each other along a vertical first seam 276 while the base assembly 270 abuts adjacent to the header 250 along a horizontal second seam 277. To secure the first and second semicircular base portions 272, 274 adjacently together in the clamshell arrangement, fastener bores 278 can be disposed through at least one base portion, normal to the axis line 275, and directed toward the other base portion. A base fastener 279 can be threaded through the fastener bore 278 and into the adjacent base portion. One of the fastener bores 278 may be a smooth walled bore and the other fastener bore may be threaded to receive the fastener 279.

Referring to FIG. 5, to provide for the clamshell style construction of the base assembly, the first semicircular base portion 272 can include a first planar axial face 280 and a first semi-cylindrical wall 282 extending from the first planar axial face. The first semi-cylindrical wall 282 may be radially oriented with respect to the axis line 275, illustrated in FIG. 5 for reference. The arc formed by the first semi-cylindrical wall 282 may conclude in a first abutment edge 284 and a second abutment edge 286 that can be generally parallel to and offset from the axis line 275; though in other embodiments the abutment edges may have different angular orientations with respect to the axis line. The first planar axial face 280 may have a smooth or flat surface, without embossments or the like, perpendicular to the first semi-cylindrical wall 282 to allow the first semicircular base portion to abut against the header. The perpendicular orientation of the first planar axial face 280 can create right angle corners between the planar axial face and the first and second abutment edges 284, 286. The first and second abutment edges 284, 286 can extend partially beyond the first planar axial face 280 so that it forms a chord offset from the axis line 275. To facilitate mounting to the header, the first semicircular base portion 272 may include one or more, relatively thin mounting tabs 288 protruding from the first planar axial face 280 and extending inwardly and normal to the axis line 275. The mounting tabs 288 may be generally coplanar to the first planar axial face 280 and may extend parallel to each other arranged to either side of the axis line 275. To facilitate operability of the filter bag, the first semicircular base portion 272 can optionally include one or more stiffening legs 289 having an elongated shape and extending vertically downwards from the first semi-cylindrical wall 282. The stiffening legs 289 can be arranged radially around the semi-cylindrical wall 282 parallel to each other and to the axis line 275 so that when the filter bag is inserted over the filter assembly, the stiffening legs expand the bag filter.

Referring to FIG. 6, the second semicircular base portion 274 can have substantial similarities to the first base portion 274 including a second planar axial face 290 and a second semi-cylindrical wall 292 descending from the second planar axial face 290. The second planar axial face 290 can have a flat, planar characteristic without embossments and the semi-cylindrical wall 292 can be radially oriented and parallel to the axis line 275, which is illustrated in FIG. 6 for reference purposes. The second semi-cylindrical wall 292 also concludes in a third abutment edge 294 and a fourth abutment edge 296 that can be perpendicular to and intersect with the second planar axial face 290 at right angles and parallel to the axis line 275. The third and fourth abutment edges 294, 296 can correspond to the first and second abutment edges 284, 286 of FIG. 5 so that, when the first base portion 270 and the second base portion 272 are assembled adjacent to each other, the abutment edges are in contiguous abutment with each other. The second planar axial face 290 may extend over only a portion of the second semi-cylindrical wall 292 so that it forms a cord offset from the axis line 275. Hence, the first and second semicircular base portions 272, 274 delineate an empty interior region or gap when assembled adjacently together to accommodate intake and outlet tubes associated with the header assembly. To facilitate assembly, the second semicircular portion 274 also includes mounting tabs 298 that extend parallel from and coplanar with the second planar axial face 290 to either side of the axis line 275. The second semicircular base portion 274 can include the optional stiffening legs 289 depending from the second semi-cylindrical wall 292 to complement the stiffening legs on the first semicircular base portion 272. Further, both the first and second semicircular base portions 272, 274 can include a semi-annular groove 299 that is radially disposed into the exterior surface of the respective first and second semi-cylindrical walls 282, 292. The semi-annular grooves 299 can align with each other when the first and second semicircular base portions are assembled together to receive a band clamp or the like for securing the bag filter to the base assembly 270.

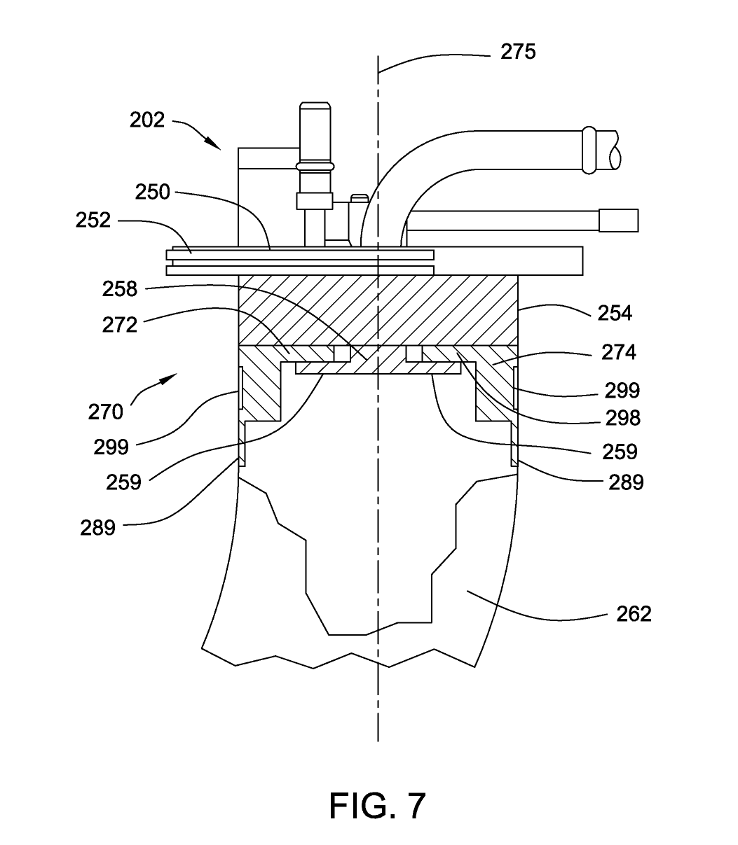

Referring to FIGS. 4 and 7, when the base assembly 270 is assembled to the header assembly 202, the base assembly connects to the underside of the header 250 adjacent to the header boss 254 with the first semicircular base portion 272 and the second semicircular base portion 274 disposed in the clamshell style arrangement. The first and second semicircular portions 272, 274 can be sized so that the assembled base assembly dimensionally corresponds to the boss diameter of the header boss 254 that descends from the larger header flange 252. To securely lock the base assembly 270 with the header assembly 202, the header 250 includes a mating structure such as a mounting plate 258 that depends downward from the bottom surface of the header boss 254. The mounting plate 258, which may be a sheet metal piece fastened to the header 250, can include outward extending plate legs 259 that are generally perpendicular to the axis line 275 and are spaced apart from the bottom surface of the header boss 254 to provide a gap or space therebetween. For assembly, the first semicircular base portion 272 is placed with the mounting tabs 288 adjacent to the bottom surface of the header boss 254 and is then moved sideways toward the axis line 275 so the mounting tabs are received in the space between the header boss and the plate leg 259. The mounting tabs 288 and the mounting plate 258 may be dimensioned to produce a relative tight, sliding fit. The second semicircular base portion 274 is similarly placed adjacent the bottom surface of the mounting plate 258 then moved horizontally to insert the mounting tabs 298 into the spaces between the plate legs 259 and the header boss 254. Securing the mounting tabs 288, 298 between the bottom surface of the header boss 254 and the plate legs 259 of the mounting plate 258 retains the base assembly 270 vertically adjacent to the header 250. The base fastener 279 illustrated in FIG. 4 can be inserted through the fastener bores 278 disposed through the semi-cylindrical walls 282, 292 to clamp the first and second semicircular base portions 272, 274 as a clamshell about the header boss 254.

An advantage of the foregoing clamshell style construction for the base assembly 270 is the creation of tight seams between the components which prevents reductant fluid from bypassing the bag filter 262 and thereby preventing any debris or contaminants in the reductant from avoiding filtration and enabling the bag filter 262 to remove these materials before they can damage or foul the SCR system downstream. In particular, the complementary first and third abutment edges 284, 294 in FIGS. 5 and 6 can cooperate to provide the vertical first seams 276 in FIG. 4. It can be appreciated that the second and fourth abutment edges 286, 296 provide a similar vertical seam that would be visible on the opposite side of the base assembly. Likewise, the first and second planar axial faces 280, 290 in FIGS. 5 and 6 can cooperate to produce the horizontal second seam 277 with the bottom surface of the header boss 254 in FIG. 4, Each of the abutment edges and planar axial faces can be configured with smooth, planar surfaces so that no significant gaps are formed at the vertical first seam 276 and the horizontal second seam 277, however, it should be noted in other embodiments the abutment edges and the planar axial faces may be arranged at different complementary angles so that the resulting seams are not exactly vertical or horizontal. Because of the contiguous relation between corresponding edges and surfaces, most reductant is directed through the bag filter during operation since it cannot bypass the bag filter through the seams.

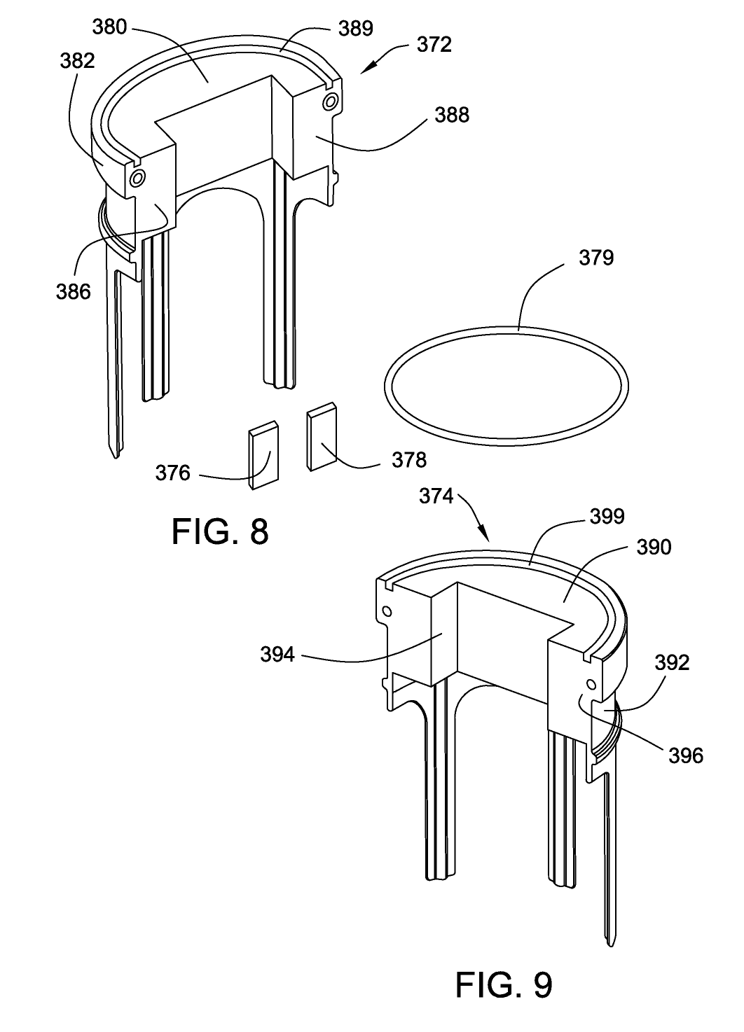

In another embodiment, to further prevent reductant from penetrating through the first and second seams and bypassing the bag filter, the seams and joints of the components can be bolstered with gaskets and/or o-rings. Referring to FIGS. 8 and 9, there is illustrated another embodiment of the first semicircular base portion 372 and the second semicircular base portion 374 for a base assembly 370 that are generally similar to the base portions of FIGS. 5 and 6. The first semicircular base portion 372 includes a first planar axial face 380 and a first semi-cylindrical wall 382 that extends perpendicularly from the first planar axial face. The first semi-cylindrical wall 382 is arranged radially with respect to the axis line 375 such that the first planar axial face 380 is perpendicular to the axis line 375. While the planar axial face 380 remains generally flat, in the present embodiment, the surface area of the planar axial face can be increased to accommodate a semi-annular o-ring groove 389 disposed vertically therein and that proceeds in a curved arrangement radially inward of and tracing the curved periphery of the semi-cylindrical wall 382. The surface area of the first and second abutment edges 384, 386 where the semi-cylindrical wall 382 concludes is likewise increased, thereby enlarging the bearing surface area they provide. Referring to FIG. 9, the second semicircular base portion 374 also includes a second planar axial face 390 perpendicularly and a second semi-cylindrical wall 392, each oriented with respect to the axis line 375 similar to the first semicircular base portion 372. In addition, the second planar axial face 390 may be enlarged to accommodate a semi-annular groove 399 disposed therein and the third and forth abutment edges 394, 396 may be enlarged to complement the first and second abutment edges 384, 386.

To seal the seams formed when the first and second semicircular base portions 372, 374 are assembled into the base assembly 370, a first and second gasket 376, 378 can be included. The first and second gaskets 376, 378 can be generally rectangular in shape and can be sized to dimensionally correspond to the first, second, third, and fourth abutment edges 384, 386, 394, 396. When the first and second semicircular base portions 372, 374 are placed adjacent to each other, the first gasket 376 can be disposed between the first and third abutment edges 384, 396 and the second gasket 378 can be disposed between the second and fourth abutment edges 386, 396. The increased surface area of the abutment edges facilitate compressing the first and second gaskets and forming a seal at the seams. Also provided can be an annular elastomeric o-ring 379 shaped and dimensioned to be received in the first and second semi-annular o-ring grooves 389, 399 that form a complete circular grooves when the first and second semicircular base portions 372, 374 are placed adjacent to each other. The o-ring is 379 is therefore arranged to seal the seam created between the base assembly 370 and the header when assembled together. The gaskets can be made of a suitable compressible material such as cork, silicone, or rubber such as neoprene, nitrile, or a fluoropolymer like perfluroelastomer. The o-ring can be made from a similar, semi-compressible material to seal the axial planar faces with respect to the bottom surface of the header according to the standard procedure known in the art. The first and second semicircular base portions 372, 374 may include additional features like the stiffening legs and tabs to facilitate construction and use of the base assembly 370.

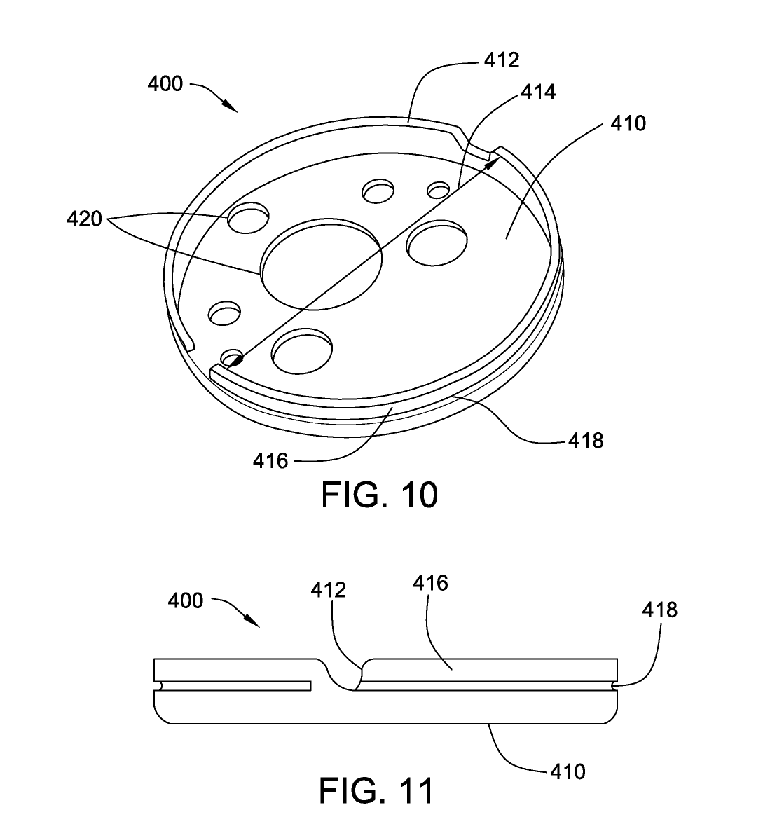

As described above, in an embodiment, the header assembly may include a mating structure in the form of a mounting plate to assist assembly with the filter assembly. In a further embodiment, the mounting plate can be configured to replace the base assembly. Referring to FIGS. 10 and 11, there is illustrated an embodiment of a mounting plate 400 having a circular, cup-shaped configuration adapted to attach to the underside of the header. The cup-shaped mounting plate 400 can include a flat, planar bottom plate 410 and a circumferential wall 412 extending perpendicularly from the peripheral edge of the planar bottom plate 410. The planar bottom plate 410 and the circumferential wall 412 can be relatively thin and, in an embodiment, can be made from stamped metal. The circumferential wall 412 may be relatively short and defines a mounting plate diameter 414 and an exterior peripheral surface 416. To accommodate an o-ring, the circumferential wall 412 may include an annular o-ring groove 418 disposed around the exterior peripheral surface 416. To accommodate the various inlet and outlet tubes associated with the header assembly, the planar bottom plate 412 may have one or more apertures 420 disposed through it.

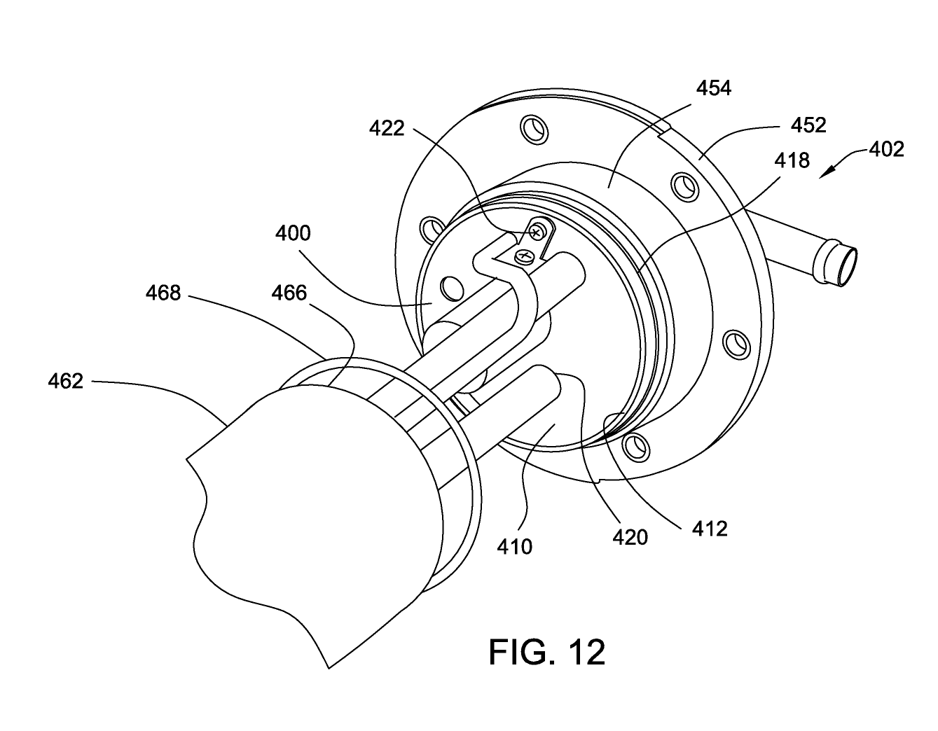

Referring to FIG. 12, to attach the mounting plate 400 to the underside of the header assembly 402, the cup-shaped mounting plate can be arranged to circumferentially receive the circular header boss 454 protruding from the header 450 within the circumferential wall 412. The mounting plate diameter may be correspondingly dimensioned with the boss diameter so the mounting plate and the header boss form a sliding fit. Additionally, the planar bottom plate 410 is dimensioned to be place adjacent to and extend generally coextensive with the bottom surface of the header boss 454. To hold the mounting plate 400 and the header 450 adjacent to each other, one or more fasteners 422 can be threaded through the planar bottom plate 410 and into the header boss 454. When joined together, the inlet and outlet tubes of the header assembly can pass through apertures 420 disposed in the bottom plate 410. To secure the bag filter 462 to the header 450, the bag opening 466 of the bag filter 462 can receive the inlet and outlet tubes extending from the header 450 so that the bag opening is dispose around and proximate to the mounting plate 400 and the header boss 454 adjacent to the underside of the header flange 452. An elastomeric o-ring 468, dimensioned to correspond with the o-ring groove 418 in the circumferential wall 412, can be installed around the bag filter 462 and the mounting plate 400. When the o-ring 468 is received in the o-ring groove 418, it can cinch or secure the bag filter 462 to the header 450. By securing the bag filter 462 directly to the mounting plate 400 and eliminating the base assembly, at least some of the seams that could leak and allow reductant to bypass the bag filter are eliminated. In various embodiments, the o-ring 468 may be a separate item or may be sewn into the bag filter 462 proximate to the periphery of the bag opening 466. In a possible embodiment, the mounting plate 400 could have stiffening legs perpendicularly attached to radially spaced around the circumferential wall 412 to insert into and hold open the bag opening 466 of the bag filter 462.

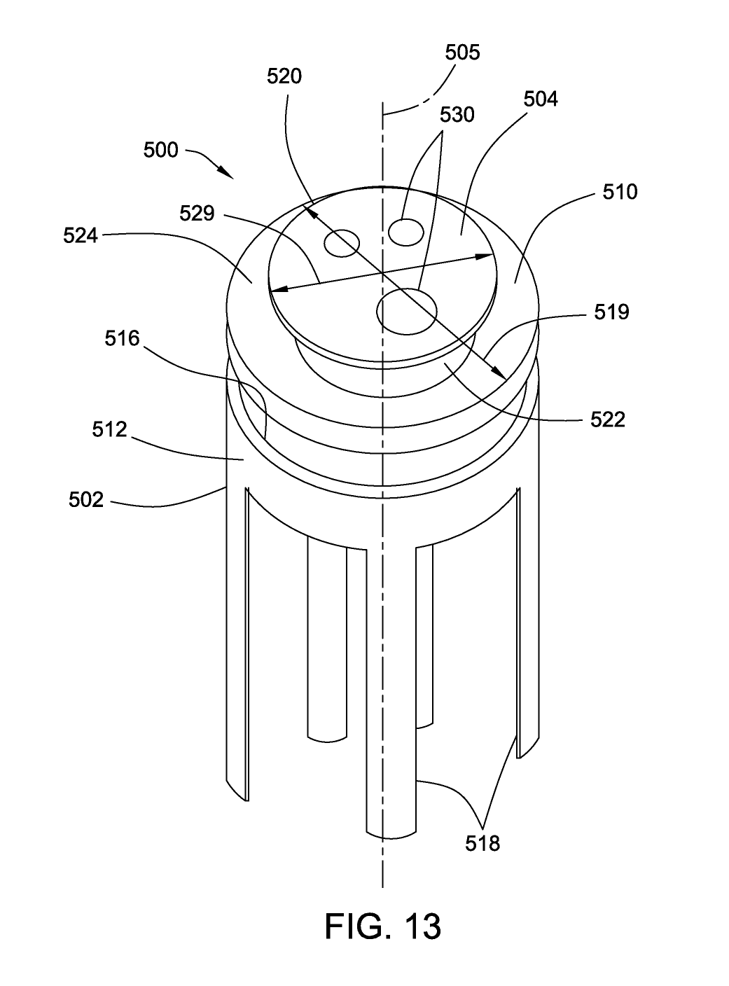

Referring to FIG. 13, in another embodiment, instead of replacing the base assembly with the mounting plate, a combined base/plate structure 500 can include both the base assembly portion 502 and the mounting plate portion 504 in an integral structure. The combined base/plate structure 500 can replace both the base assembly and the mounting plate with a single item for inclusion with the header assembly. As in the previous embodiments, the base assembly portion 502 is adapted for insertion into a bag filter and can be generally cylindrical in shape including a planar axial face 510 and a cylindrical wall 512 that descends perpendicularly from the planar axial face. The cylindrical wall 512 can extend coextensively around and delineate an axis line 505 of the combined base/plate structure 500. The planar axial face 510 and the cylindrical wall 512 may delineate a base assembly diameter 519 associated with the base assembly portion 502. To secure the bag filter to the combined base/plate structure 500, the cylindrical wall 512 may include an annular groove 516 concentric to the axis line 505 that can receive a band clamp or the like to cinch the opening of the bag filter to the cylindrical wall. In an embodiment, to facilitate interaction with the bag filter, one or more, radially spaced stiffening legs 518 can depend from the periphery of the cylindrical wall 512 to hold the bag filter open during operation.

To interface with the header, the mounting plate portion 504 can be disposed above the planar axial face 510 of the base assembly portion 502. In the illustrated embodiment, the mounting plate portion 504 can have a top plate 520 that is parallel to and spaced above the planar axial face 510 by a narrower diameter neck 522. The top plate 520 may be circular and may have a mounting plate diameter 529 dimensionally sized between the diameters of the neck 522 and the base assembly diameter 519 of the base assembly portion 502, however, in other embodiments, the top plate 520 may have other shapes. The top plate 520 may be spaced above the planar axial face 510 by the neck 522 so that the peripheral edge 524 of the top plate 520 hangs over the planar axial face 510. Due to the spacing, the top plate 520 can mate with or be grasped by appropriately shaped claws or the like depending from the header to connect with the combined base/plate structure 500. To accommodate inlet and outlet tubes from the header, the base assembly portion 502 and the mounting plate portion 504 may have one or more tube apertures 530 disposed through them and extending generally parallel to the axis line 505. In the illustrated embodiment, the combined base/plate structure 500 can be made as an integral structure, for example, out of cast or sintered metal or molded plastic, with the base assembly portion 502 and the mounting plate portion 504 contiguously joined together. The combined base/plate structure 500 thereby eliminates at least some of the seams that could otherwise leak and allow reductant to bypass the bag filter. The integral nature of the combined base/plate structure also eliminates the need for gaskets and o-rings to seal separate components. In the embodiment where in the combined base/plate structure 500 is integrally formed, the stiffening legs 518 can be produced separately and clipped, bolted, welded, or fused onto the base assembly portion 502.

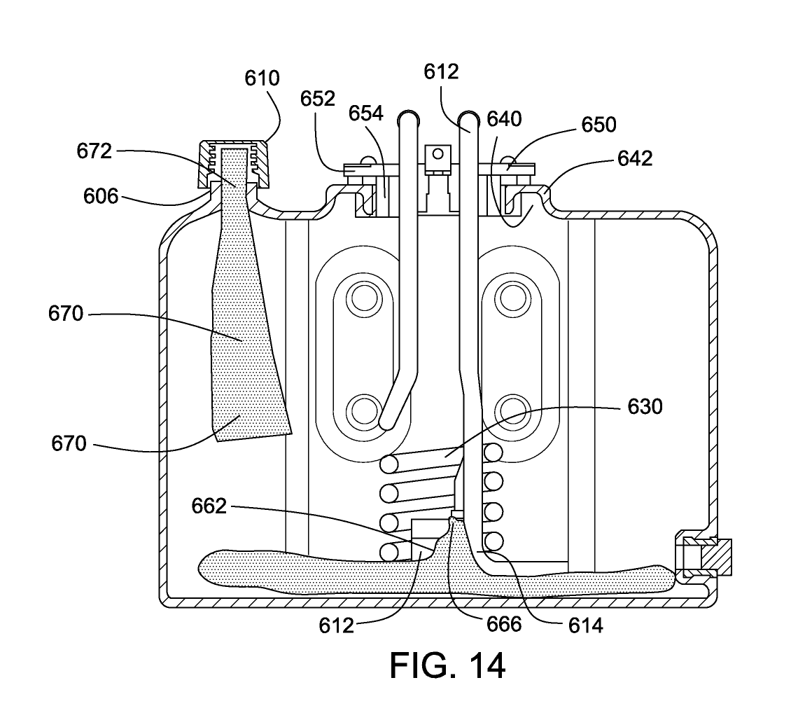

Referring to FIG. 14, there is illustrated another embodiment of the reservoir 600 and a header assembly 602 communicating with a reservoir volume 604 delineated by the reservoir. The reservoir volume 604 is accessible via a fill opening 606 selectively opened and closed by a removable fill cap 610 to receive reductant fluid for use in an SCR system. The header assembly 602 accommodates various inlet and outlet tubes including, for example, a supply tube 612 that descends to a sump and that terminates at an inlet port 614 inside the reservoir volume 604 and a heater device 630 disposed in the reservoir volume 604. To accommodate the header assembly 602 for directing reductant and other fluids to and from the reservoir volume 604, the reservoir 600 includes a header opening 640 disposed through a reservoir embossment 642 formed on the top of the reservoir. The inlet and outlet tubes may be secured in a plastic molded header 650 that is removably installable in the header opening 640. In particular, the header 650 can include a larger diameter header flange 652 adapted to be disposed adjacent to and supported in an abutting relation by the reservoir embossment 642 and a smaller diameter header boss 654 that can be received partially through the correspondingly dimensioned header opening 640. Although the header opening 640 and the header 650 are illustrated to be circular in shape, in other embodiments they may have other complementary shapes.

To filter contaminants from the reductant stored in the reservoir volume 604 before it is drawn through the supply tube 612, the reservoir 600 in the present embodiment can include a filter assembly 660 that accommodates an enlarged bag filter 662. The enlarged bag filter 662 may have a much larger surface area than the bag filter described in FIGS. 3 and 4 above. The increased surface area, by providing additional filtration material, corresponds to increased filtration service life so that the filter assembly 660 can operate for longer periods before requiring maintenance or cleansing. Also unlike the sock-like, tubular bag filter described in FIGS. 3 and 4, the enlarged bag filter 662 does not have a definitive shape but can be made from a flexible sheet material of any suitable filtration material mentioned herein. The lack of definitive shape facilitates inserting the enlarged bag filter 662 through the smaller header opening 640 by allowing the enlarged bag filter to be distorted or folded over itself. Once inside the reservoir volume 604, the enlarged bag filter 662 can unfold and drape itself across the floor or the bottom of the reservoir 600. In addition to providing increase surface area, the enlarged bag filter may be able to access reductant at far reaching corners of the reservoir volume 604. To connect the enlarged bag filter 662 with the header assembly 602, the enlarged bag filter can include a bag opening 666 that can partially receive the supply tube 612 and that can be secured thereto by band clamps, cinch ties, or the like prior to installation of the header assembly 602 on the reservoir 600. The header assembly 602 can be periodically removed for cleaning the enlarged bag filter 662.

In addition to the enlarged bag filter 662, the present embodiment of the reservoir 600 may also include an enlarged inlet filter 670 operatively associated with the fill opening 606. Like the enlarged bag filter 662, the inlet filter 670 may be highly pliable, bag-like structure of indefinite shape made from flexible sheet material sewn together to provide an enclosure. An inlet 672 of the inlet filter 670 can be removably disposed in the fill opening 606 with the remainder of the inlet filter descending into the reservoir volume 604. The inlet filter 670 receives reductant being added to the reservoir 600 and filters the reductant before it encounters the rest of the reservoir volume 604. The inlet filter 670 can also trap an large dirt particles and other debris that may inadvertently fall into the fill opening 606. The inlet filter 670 can be removed for periodic cleansing. In various embodiments, the inlet filter 670 may be used in cooperation with any of the filter assemblies associated with the header assembly described above.

### INDUSTRIAL APPLICABILITY

The present disclosure is applicable to emission control systems for engines and, more particularly, to emission control systems using SCR processes requiring the injection of fluid reductant like urea-based water solutions into engine exhaust streams. In the disclosed embodiments, a two-stage filtering arrangement for a feed of reductant from a reservoir is described, which is advantageously configured to provide sufficient protection from debris, such as silt, dirt, fibers and the like, or transient debris such as ice, from entering into a pumping system and/or otherwise clogging flow passages out from the reservoir.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A base assembly of a clamshell type, two piece construction for attachment to a header and disposable in a fluid reservoir for fluid reductant, the base assembly comprising:
a first semicircular base portion having a first planar axial face and a first semi-cylindrical wall extending from the first planar axial face, the first semi-cylindrical wall concluding in first abutment edge and a second abutment edge, the first abutment edge and the second abutment edge of the first semicircular base portion oriented generally perpendicular to the first planar axial face;
a second semicircular base portion having a second planar axial face and a second semi-cylindrical wall extending perpendicularly from the second planar axial face; the second semi-cylindrical wall concluding in a third abutment edge and a fourth abutment edge, the third abutment edge and the fourth abutment edge of the second semicircular base portion oriented generally perpendicular to the second planar axial face; wherein
when assembled, the first abutment edge and the third abutment edge form a first contiguous abutting seam and the second abutment edge and the fourth abutment edge for a second contiguous abutting seam.

2. The base assembly of claim 1, wherein the first semicircular base portion includes a mounting tab extending inwardly from the first semi-cylindrical wall perpendicular and generally adjacent to the first axial face.

3. The base assembly of claim 2, wherein the first abutment edge and the second abutment edge interface with the first planar axial face at corners of approximately right angles and the third abutment edge and the fourth abutment edge interface with the second planar axial face at approximately right angles.

4. The base assembly of claim 3, wherein the first semi-cylindrical wall of the first semicircular base portion includes a first fastener bore disposed therethrough to accept a fastener and the second semi-cylindrical wall of the second semicircular base portion includes a second fastener bore to accept the fastener.

5. The base assembly of claim 1, wherein the first semi-cylindrical wall includes a first semi-annular groove disposed radially about an exterior surface of the first semi-cyclindrical wall, and the second semi-cylindrical wall includes a second semi-annular groove disposed radially about an exterior surface of the second semi-cylindrical wall.

6. The base assembly of claim 1, wherein the first semicircular base portion and the second semicircular base portion each form approximately 180° of the base assembly.

7. The base assembly of claim 6, wherein the first semicircular base portion and the second semicircular base portion define an axis line when assembled together.

8. The base assembly of claim 1, further comprising a gasket disposed between the first abutment edge and the third abutment edge and a gasket disposed between the second abutment edge and the fourth abutment edge.

9. The base assembly of claim 8, wherein the first planar axial face includes a first semi-annular o-ring groove and the second planar annular face includes a second semi-annular o-ring groove, the first semi-annular o-ring groove and the second semi-annular o-ring groove adapted to receive a circular o-ring.

10. A header assembly insertable on a fluid reservoir for reductant fluid, the header assembly comprising:
a header including a header flange having a flange diameter and a header boss descending from the header flange, the header boss having a boss diameter less than the flange diameter of the header flange;
a mounting plate having a cup-shaped adapted to attach to the header boss, the mounting plate including a planar bottom plate and a circumferential wall extending perpendicularly from a circular edge of the planar bottom plate, the circumferential wall having a mounting plate diameter dimensioned to circumscribe the boss diameter; and
a bag filter secured to the mounting plate and descending from the header.

11. The header assembly of claim 10, wherein the bag filter includes an bag opening adapted to surround the circumferential wall of the mounting plate.

12. The header assembly of claim 11, wherein the bag filter is secured to the mounting plate with an o-ring disposed around the bag filter and the header boss proximate to the bag opening.

13. The header assembly of claim 12, wherein the circumferential wall of the mounting plate has an annular o-ring groove disposed therein to receive the o-ring.

14. The header assembly of claim 13, wherein the planar bottom plate is coextensive with the header boss.

15. The header assembly of claim 14, further comprising a supply tube disposed through the header and the mounting plate, the supply tube descending within and enclosed by the bag filter.

16. A header assembly insertable in a fluid reservoir for reductant fluid, the header assembly comprising
a header having a header flange with a flange diameter and header boss protruding from the header flange and having a boss diameter smaller than the flange diameter; and
a combined base/plate structure integrally formed together and including a base assembly portion having a planar axial surface and a mounting plate raised above the planar axial surface, the mounting plate adapted for mounting to an underside of the header; and
a supply tube disposed through the header flange and secured in the header, the supply tube descending through the combined base/plate structure.

17. The header assembly of claim 16, wherein the combined base/plate structure is integrally formed of metal.

18. The header assembly of claim 17, wherein the combined base/plate structure is integrally formed of plastic.

19. The header assembly of claim 18, wherein the combined base/plate structure includes an annular groove disposed in a cylindrical wall of the base assembly.

20. The header assembly of claim 19, wherein the combined base/plate structure includes a base assembly diameter larger than a mounting plate diameter associated with the mounting plate.
